(19) United States
(12) Patent Application Publication
(10) Pub. No.: US 2013/0275721 A1
(43) Pub. Date: Oct. 17, 2013

(54) RECONFIGURABLE INSTRUCTION ENCODING METHOD, EXECUTION METHOD, AND ELECTRONIC APPARATUS

(71) Applicant: INDUSTRIAL TECHNOLOGY RESEARCH INSTITUTE, Hsinchu (TW)

(72) Inventors: Huang-Lun Lin, Tainan City (TW); Shui-An Wen, Taichung City (TW); Chi Wu, New Taipei City (TW); Tzu-Fang Lee, Hsinchu City (TW)

(73) Assignee: INDUSTRIAL TECHNOLOGY RESEARCH INSTITUTE, Hsinchu (TW)

(21) Appl. No.: 13/901,640

(22) Filed: May 24, 2013

Related U.S. Application Data
(63) Continuation-in-part of application No. 13/448,659, filed on Apr. 17, 2012.

(30) Foreign Application Priority Data
Nov. 6, 2012 (TW) 101141138

(51) Int. Cl. G06F 9/30

(52) U.S. Cl. CPC G06F 9/3016
USPC 712/208

(57) ABSTRACT

Reconfigurable instruction encoding method, and execution method and electronic apparatus are provided. In the reconfigurable instruction encoding method, in an embodiment, instruction pairs of an application are encoded and re-encoded according to the number of times that the instruction pairs are utilized in the application to generate an instruction encoding table and an instruction mapping table. The reconfigurable instruction execution method includes: loading an instruction mapping table to a processing unit having an instruction mapping module, an instruction decoding module, and an execution module; converting a first instruction of an application to a target instruction by the instruction mapping module according to the instruction mapping table; and decoding the target instruction and executing the decoded target instruction by the decoding module and the execution module, respectively.

This application is a continuation-in-part application of application Ser. No. 13/448,659, filed Apr. 17, 2012, and this application claims the benefit of Taiwan application Serial No. 101141138, filed Nov. 6, 2012, the disclosure of which is incorporated by reference herein in its entirety.

### TECHNICAL FIELD

The disclosed embodiments relate to an instruction encoding method, execution method, and processor architecture.

### BACKGROUND

To perform program compiling for a processor, a compiler converts source code of an application to binary encoding according to a fixed instruction table corresponding to an instruction set architecture for the processor, so as to enable the processor to perform corresponding computing operations.

To execute an application in a computing apparatus, binary encoding of the application stored in a memory device in the computing apparatus is transmitted to a processor of the computing apparatus via an instruction bus. The transmission of consecutively executed instructions may cause dramatic logic signal transition between continuous instructions on the the bus when different application programs are compiled or assembled, inducing rapid logic signal transition on CMOS circuit input-ends, resulting in power consumption problem.

### SUMMARY

The disclosure is directed to an instruction encoding method, execution method, and processor architecture.

According to one embodiment, a reconfigurable instruction execution method for an electronic apparatus is provided. The reconfigurable instruction execution method comprises the following steps. An instruction mapping table is loaded to a processing unit of the electronic apparatus, wherein the processing unit comprises an instruction mapping module, an instruction decoding module, and an execution module. A first instruction of an application is fetched by the processing unit. The first instruction is converted to a target instruction according to the instruction mapping table in the instruction mapping module. The target instruction is decoded by the instruction decoding module, and the decoded target instruction is executed by the execution module.

According to another embodiment, an electronic apparatus is provided. The electronic apparatus comprises a processing unit. The processing unit, for executing an instruction according to an instruction mapping table, comprises an instruction mapping module, an instruction decoding module, and an execution module. The instruction mapping module converts a first instruction fetched by the processing unit to a target instruction according to the instruction mapping table. The instruction decoding module decodes the target instruction, and the execution module then executes the decoded target instruction.

According to an alternative embodiment, a reconfigurable instruction encoding method for execution in a computing device is provided. The reconfigurable instruction encoding method comprises the following steps. Distribution of adjacent instruction pairs within an application is counted, and a group of instruction pairs is accordingly determined, wherein the group of instruction pairs includes instruction pairs having higher utilization rates in the application. The instruction pairs having the higher utilization rates are encoded to similar binary encodings and an instruction encoding table is generated accordingly, wherein the generated instruction encoding table and has the same number of instructions as that of an original instruction encoding table, and an encoding of at least one instruction in the generated instruction encoding table is different from that of the at least one instruction in the original instruction encoding table. An instruction mapping table is generated, wherein the instruction mapping table includes a mapping relationship between the generated instruction encoding table and the original instruction encoding table.

According to yet another embodiment, a computing apparatus readable information storage medium is provided. The information storage medium stores program code for executing the foregoing reconfigurable instruction encoding method.

### BRIEF DESCRIPTION OF THE DRAWINGS

FIG. 1 is a block diagram of a hardware architecture for reconfigurable instruction encoding according to one embodiment.

FIG. 2 is a flowchart of a reconfigurable instruction execution method according to one embodiment.

FIG. 3 is a circuit block diagram of the instruction mapping module in FIG. 1 according to one embodiment.

FIG. 4 is a block diagram of a processor architecture for reconfigurable instruction encoding according to one embodiment.

FIG. 5 is a flowchart of a reconfigurable instruction encoding method according to one embodiment.

FIG. 6 is a flowchart of one embodiment of the profiling step of program code in FIG. 5

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

### DETAILED DESCRIPTION

Embodiments of a reconfigurable instruction encoding method, execution method and processor architecture are given below. In some embodiments, a processor architecture comprising an instruction mapping module is disclosed to allow a processor to execute an application based on a reconfigurable instruction set. In some embodiments, an encoding method for generating a reconfigurable instruction set for an application is disclosed. In some embodiments, a reconfigurable instruction encoding method capable of reducing the Hamming distance between adjacent instructions is disclosed. In some embodiments, the reconfigurable instruction encoding method executed in a computing device.

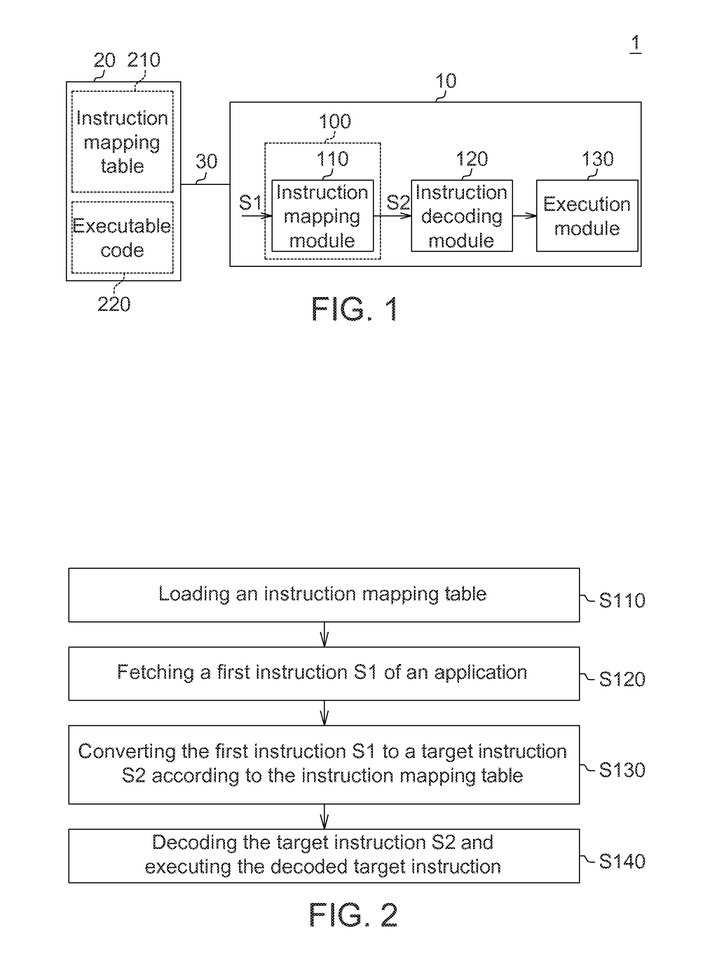

FIG. 1 shows a block diagram of a hardware architecture 1 for reconfigurable instruction encoding according to one embodiment. The hardware architecture 1 comprises a processing unit 10 and a memory unit 20. For example, the processing unit 10 comprises an instruction mapping module 110, an instruction decoding module 120, and an execution module 130. It should be noted that, in other embodiments, the processing unit 10 may be implemented as a single-core or multi-core processor, a processor based on a pipelined circuit, a processor based on a very long instruction word (VLIW) circuit, or a processor in other architectures. For another example, the instruction mapping module 110 of the processing unit 10 may be included in an instruction fetching module 100, or coupled between an instruction fetching module and the instruction decoding module 120.

In FIG. 1, the processing unit 10 executes an instruction according to an instruction mapping table 210. For example, the processing unit 10 executes executable code 220 of an application. The instruction mapping module 110 converts a first instruction S1 retrieved by the processing unit 10 to a target instruction S2 according to the instruction mapping table 210. The instruction decoding module 120 decodes the target instruction S2, and then the execution module 130 executes the decoded target instruction S2. The memory unit 20, coupled to the processing unit 10 via a bus 30, stores the instruction mapping table 210 and multiple executable codes 220 of an application. The memory unit 20 may be implemented as the same or different kinds of memory modules or devices. Further, during the execution process of the executable code 220 of the application, the processing unit 10 may fetch at least one or multiple instructions from the memory unit 20. The at least one or multiple instructions of the executable code 220 may be parallel or serial data represented by the first instruction S1.

In FIG. 1, the processing unit 10 is an architecture having an instruction set, e.g., a processor architecture based on reduced instruction set computing (RISC) architecture, or a microprocessor without interlocked pipeline stage (MIPS) architecture. With the architecture having the instruction mapping module 110, the processing unit 10 is enabled to execute an application generated (or encoded) based on a reconfigurable instruction set. The instruction code represented by the target instruction S2 outputted by the instruction mapping module 110 according to the instruction mapping table 210 matches the instruction set for the processing unit 10. Hence, the instruction decoding module 120 is capable of decoding the instruction code according to the instruction set for the processing unit 10, and the decoded instruction code can then be executed by the execution module 130. As such, the processing unit 10 may be regarded as a processing unit capable of dynamically adjusting the instruction set.

FIG. 2 shows a flowchart of a reconfigurable instruction execution method according to one embodiment. For example, the method in FIG. 1 is explained by taking the hardware architecture 1 in FIG. 1 as an example.

In step S110, an instruction mapping table is loaded to a processing unit 10 of an electronic apparatus. The electronic apparatus may be regarded as the processing unit 10, or may be a system-on-chip (SoC) based on the processing unit 10. Alternatively, the electronic apparatus may be a computing apparatus based on the processing unit 10, e.g., a smart handset, a portable pad, a laptop computer, a personal computer, or a mobile device or embedded system such as a multimedia player. In step S110, which may be performed before the processing unit 10 executes an application according to the instruction mapping table, the processing unit 10 controls the instruction mapping module 110 to load the corresponding instruction mapping table. Alternatively, in step S110, one or multiple instruction mapping tables are pre-stored in the processing unit 10 for use of executing an application, and a corresponding instruction mapping table may be then selected for an application being executed.

In step S120, a first instruction S1 of an application is retrieved by the processing unit 10. For example, the first instruction S1 may be retrieved by an instruction fetching module or the instruction mapping module 110 of the processing unit. For another example, the instruction mapping table and the first instruction S1 may be fetched from the memory unit 20 of the electronic apparatus by the processing unit 10. The first instruction S1, e.g., in the form of a binary encoding, represents at least one among multiple executable codes of the application.

In step S130, the first instruction S1 is converted to a target instruction S2 by the instruction mapping module 110 according to the loaded instruction mapping table.

In step S140, the target instruction S2 is decoded by the decoding module 120, and the decoded target instruction is executed by the execution module 130.

In step S130, for example, the first instruction S1, e.g., in the form of a binary encoding, includes an encoded instruction code (e.g., 1001 representing an instruction ADD), and the target instruction S2, e.g., in the form of another binary encoding, includes an original instruction code (e.g., 1110 representing the instruction ADD). The instruction mapping table includes a one-to-one mapping relationship between the encoded instruction code and the original instruction code. According to the mapping relationship in the instruction mapping table, the first instruction S1 is converted to the target instruction S2 by the instruction mapping module 110. In an alternative embodiment, the instruction mapping table may also include many-to-one relationships between multiple different encoded instruction codes to the same original instruction code (e.g., 1011 and 1101 both representing the same instruction ADD).

In one embodiment, steps S110 to S140 are performed in an electronic apparatus.

From another aspect, the instruction mapping table includes function relationships (one-to-one or many-to-one mapping relationships) between multiple encoded instruction codes and multiple original instruction codes. The executable codes of the application are generated based on the encoded instruction encoding table, and the instructions in the original instruction encoding table are included in an instruction set for the processing unit 10.

With the above embodiments, the processing unit 10 may be regarded as a processing unit capable of dynamically adjusting encoded codes of the instruction set. As the processing unit 10 is capable of executing applications encoded from different instruction encoding tables, not only formidable flexibilities are offered also diversified applications can be derived when implementing the processing unit 10 and executing the applications. In one embodiment, for programs of instruction sets for other processors, an instruction mapping table may be designed or generated to coordinate with the instruction mapping module, so that the programs based on instruction sets for other processors may also be executed in the processing unit 10 through conversion performed by the instruction mapping module. In some embodiments, an instruction mapping table may be designed or generated, such that the Hamming distance between every two adjacent executable codes of the application is on the whole (i.e., with respect to the distribution of instruction pairing) smaller than the Hamming distance between every two adjacent executable codes converted by the instruction mapping module according to the instruction mapping table. Details for generating the instruction mapping table and the reconfigurable instruction encoding method shall be given with examples.

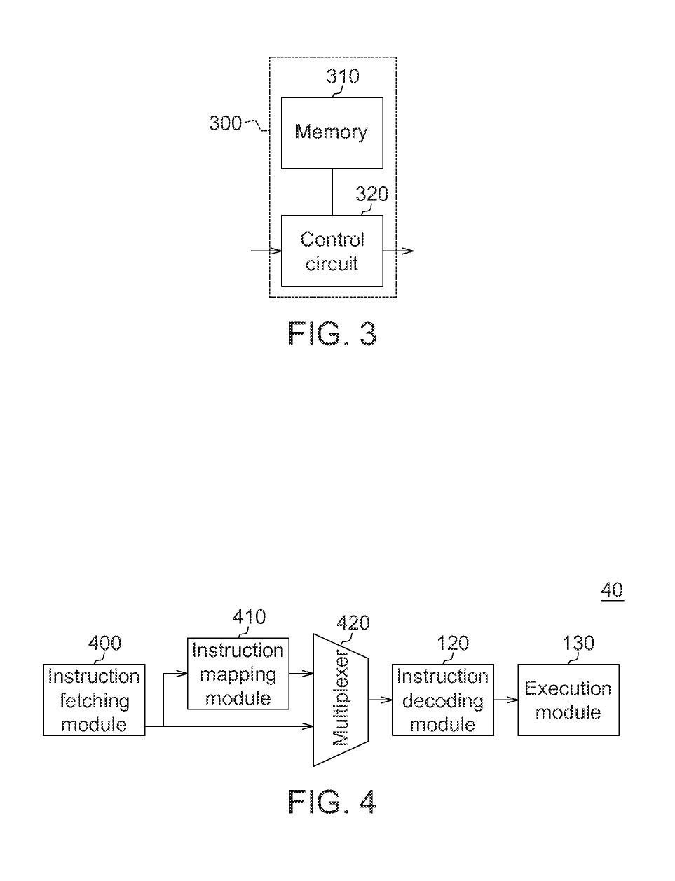

FIG. 3 shows a circuit block diagram of the instruction mapping module in FIG. 1 according to one embodiment. In FIG. 3, an instruction mapping module 300 comprises a memory 310 (e.g., a register or another type of memory) and a control circuit 320 (e.g., a logic circuit or a combination of other circuits). The control circuit 320 loads the instruction mapping table to the processing unit 10, and converts the first instruction S1 to the target instruction S2 according to the instruction mapping table.

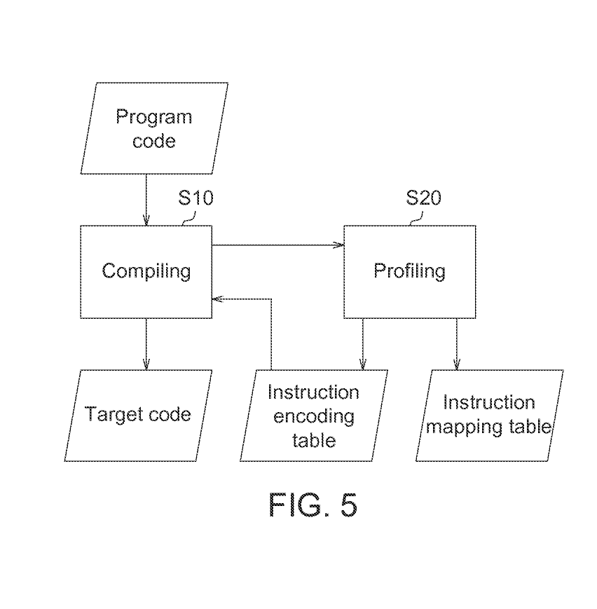

FIG. 4 shows a block diagram of a processor architecture for reconfigurable instruction encoding according to one embodiment. Compared to the processing unit 10 in FIG. 1, a processor 40 in FIG. 4 further comprises an instruction fetching module 400 and a multiplexer 420. The instruction fetching module 400 fetches the first instruction S1. The multiplexer 420 has multiple input ends coupled to the instruction mapping module 410 and the instruction fetching module 400, and an output end coupled to the instruction decoding module 120. According to an instruction (e.g., from an operating system or a system circuit of an electronic apparatus), the processing unit 40 controls the multiplexer 420 to select an output from either the instruction mapping module 410 or the instruction fetching module 400 as an output of the multiplexer 420. In one embodiment, the processing unit 40 may have a mapping mode and an original mode. In the original mode, the processing unit 40 is capable of executing executable codes (e.g., instructions of system programs, an operating system, or a general application) obtained from compiling according to original instruction encoding, without undergoing the processing of the instruction mapping module 410. Thus, the output from the instruction fetching module 400 is forwarded to the instruction decoding module 120 through the multiplexer 420. In the mapping mode, with the processing of the instruction mapping module 410, the processing unit 40 may execute executable codes (e.g., an application such as an application generated by an example in FIG. 5) of a program obtained from compiling according to an instruction encoding table. Thus, the output from the instruction mapping module 410 is forwarded to the instruction decoding module 120 through the multiplexer 420. In yet another embodiment, in the original mode, the instruction mapping module 410 may be enabled into a power-saving state. As such, the processor architecture for reconfigurable instruction encoding may be implemented as the foregoing embodiments or other embodiments modified from the foregoing embodiments.

FIG. 5 shows a flowchart of a reconfigurable instruction encoding method according to one embodiment. The reconfigurable instruction encoding method according to one embodiment may be performed in a computing apparatus having a processor and a memory. Referring to FIG. 5, in step S10, source code of an application is encoded to target code based on an instruction set, by a compiler, for example. For example, the target code is machine code, executable code or binary code. During the process of generating the target code in step S10, the source code is compiled to program code represented in assembly or pseudo code, and then converted to the target code based on a particular instruction set encoding. The target code can be processed by the instruction decoding module and the execution module of a processor constructed based on the instruction set.

In step S20, profiling of the program code is performed to generate an instruction encoding table and an instruction mapping table by counting distribution of instruction pairs in the program code (e.g., represented in an assembly). For example, step S20 may be implemented in a compiler or by one or multiple software modules utilized by a compiler. The instruction encoding table is for the use of compiling in step S10, in which the program code represented in assembly is converted to the target code, based on the instruction encoding table, rather than the original instruction set. The relationship between instructions and instruction codes (i.e., binary encoding) in the instruction encoding table is different from that of the original instruction set encoding, and thus the instruction encoding table can be regarded as reconfigured instruction set encoding. Therefore, the instruction mapping table is for the use of executing the target code by a processing unit constructed based on the original instruction set encoding. As shown in the embodiments from FIG. 1 to FIG. 4, the processing unit is enabled to execute the application by the instruction mapping module according to the instruction mapping table. The instruction mapping table includes a mapping relationship between the instruction encoding table and an original instruction encoding table. Both of the instruction mapping table and the target code may be included in an application file or in separate files, or may be in different software modules.

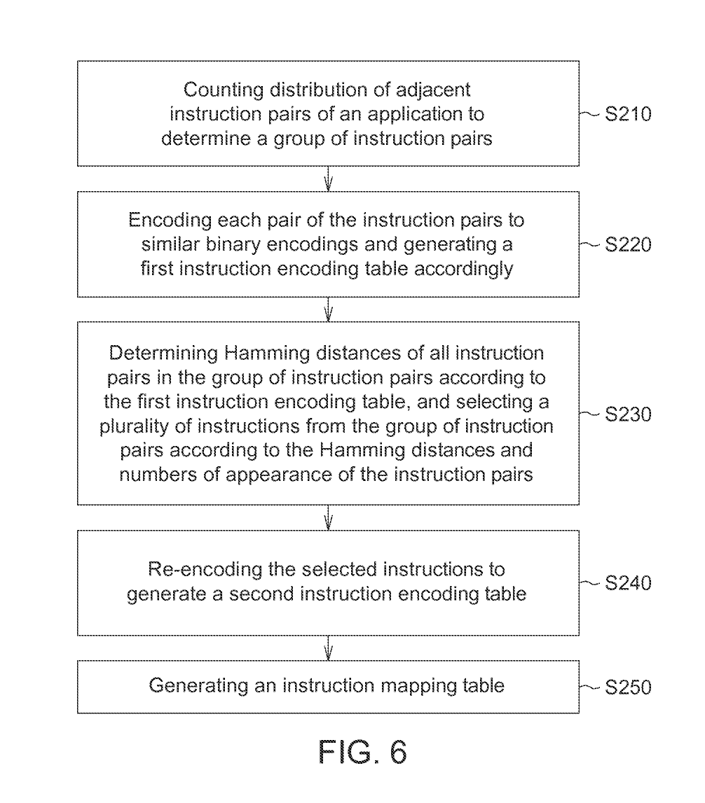

FIG. 6 shows a flowchart of the profiling step for program code in FIG. 5 for implementing a reconfigurable instruction encoding method according to one embodiment.

In step S210, distribution of adjacent instruction pairs within an application are counted to obtain a group of instruction pairs (e.g., at least including a portion of the instructions in the original instruction encoding table), which comprises multiple instruction pairs having higher utilization rates (e.g., having greater numbers of appearance in terms of the program code level) within the application.

In step S220, each pair of the instruction pairs having the higher utilization rates (e.g., a portion or all of the instruction pairs of the group of instruction pairs) are encoded to similar binary encodings and a first instruction encoding table is generated accordingly. The first instruction encoding table and an original instruction encoding table have the same number of instructions, and an encoding of at least one instruction in the first instruction encoding table is different from that in the original instruction encoding table.

In step S230, a Hamming distance of each pair of the instruction pairs in the group of instruction pairs is determined according to the first instruction encoding table, and multiple instructions are selected from the group of instruction pairs according to the Hamming distances and the numbers of appearance of the instruction pairs in the group of instruction pairs.

In step S240, the selected instructions are re-encoded to obtain a second instruction encoding table. At least one additional binary encoding is assigned to each of the selected instructions by the re-encoding step. The second instruction encoding table is an extension based on the first instruction encoding table and comprises the additional binary encoding.

In step S250, an instruction mapping table is generated. The instruction mapping table includes a mapping relationship between the second instruction encoding table and the original instruction encoding table.

Thus, executable codes of the application can be generated using a compiler according to the second instruction encoding table and instructions of the application.

In some embodiments, an encoding method selection module or step can be implemented in the compiler or an assembler so that the compiler or assembler, if one instruction corresponds to multiple encoded instruction codes, generates corresponding binary encoding having a least logic signal transition on an instruction bus between the instruction and its adjacent instruction(s). In the compiler or assembler, a module or step for encoding selection selects an optimal encoding according to the instruction encoding table, so that the selected optimal encoding renders a shorter Hamming distance between the instruction and its adjacent instructions. For example, two adjacent instructions, e.g., IN1 and IN2, are processed and the instruction IN1 corresponds to (1001, 0101) and IN2 corresponds to (0100). The instruction codes that render a smaller Hamming distance between the instructions IN1 and IN2 are selected, i.e., IN1:0101, IN2:0100.

In one embodiment, step S220 for generating the instruction encoding table comprises the following. Multiple instructions of the group of instruction pairs are paired. More specifically, the instructions are paired according to the utilization rate from high to low, starting from the instruction having the highest utilization rate, and the instruction pairs are further assigned with similar instruction codes. The instruction encoding table is generated by encoding the instruction pairs.

In some embodiments, step S230 determines the selected instructions according to various relationships, such as the Hamming distance and the number of appearance of the instructions. For example, the instructions are selected according to the product of the Hamming distance by the number of appearance. In other words, in this example, the selected instructions are the instruction pairs having greater products of the Hamming distances by the numbers of appearance from the instruction set. For example, 2, 4 or 10 instruction pairs having greater products are selected.

An example is given below for describing the compiling step of program code according to one embodiment. A Parallel Architecture Core (PAC)-Lite processor developed by Industrial Technology Research Institute (ITRI) of Taiwan is taken as an example. The PAC-Lite processor employs an instruction set having a fixed length of 32 bits. A format of the instructions is substantially represented as: oooo ccc fff dddddd sssssttttt aaaaaa, wherein o's are associated with the operation code (opcode) of the instructions and represent the type of the operation code with 4 bits, and f's represent the functions of the operation code with 3 bits. An operation code is composed of a type code and a function code, i.e., oooo fff. For example, an original instruction set for the PAC-Lite processor is as shown in Table-1.

TABLE 1

| Type | Instruction |
|---|---|
| 0000 | NOP, TRAP |
| 0001 | LW, LH, LHU, LB, LBU |
| 0011 | SLT, SUB, AND, OR, XOR, MIN, MINU, MAX, MAXU, SLL, |
| | SRL, SRA |
| 0010 | SRAI, BRR, SB |
| 0100 | ABS, NEG, NOT, COPY |
| 0101 | ADDI, SLLI, SRLI, SW |
| 0111 | ORP |
| 1101 | SH, LBCB |
| 1110 | BR |
| 1111 | B |
| 1000 | ANDP, MOVI.L, MOVI.H |
| 1001 | NOTP |
| 1010 | ADD, SEQ |

For the sake of brevity, only the type code is listed for the instructions denoted by mnemonics in Table-1. For the same type of instructions, function codes corresponding to the instructions may be defined according to the sequence of the instructions in Table-1, e.g., encoded in binary codes, Gray codes or other encoding methods. For example, the instruction NOP and TRAP may respectively be defined as 0000 000 and 0000 001.

In the example below, it is assumed that the processing unit 10 is constructed based on the instruction set for the above PAC-Lite processor. To reduce power consumption resulted by frequent bus logic level transition when instructions within an application are transmitted at the bus 30, an instruction encoding table and an instruction mapping table as well as target code corresponding to the application are generated by the methods in FIGS. 5 and 6.

Details for generating an instruction encoding table and an instruction mapping table according to the method in FIG. 6 are given below.

By step S210, distribution of pairs of adjacent instructions (as shown in Table-2) of an application are counted to determine a group of instruction pairs. The “instruction pairs” column in Table-2 represents two adjacent instructions within an application (e.g., represented in assembly), e.g., MOVI.H-MOVI.L, ADD-SRLI, and ADD-SLLI. The column N represents the number of times that the instruction appears, i.e., the number of appearance for all or some of the adjacent instructions in the codes of the application. The group of instruction pairs IP0 at least includes a portion of the instructions in the original instruction encoding table (OIT, as shown in Table-1). The group of instruction pairs includes multiple instruction pairs having a higher utilization rate in the application. For example, the instruction pairs are ordered with respect to the statistical distributions from high to low, as shown in Table-2. That is, the instruction pairs appearing for a greater number of times (i.e., having a higher utilization rate) are arranged first, followed by the instruction pairs appearing for a smaller number of times (i.e., having a lower utilization rate).

TABLE 2

| Instruction pair | T | N |
|---|---|---|
| MOVI.H-MOVI.L | 1(1) | 8162 |
| ADD-SRLI | 2(5) | 6720 |
| ADD-SLLI | 3(4) | 5760 |
| SLLI-ADD | 3(4) | 5760 |
| MOVI.L-MOVI.H | 1(1) | 5378 |
| LHU-ADD | 2(5) | 3840 |
| SRLI-SH | 3(2) | 3840 |
| SH-LHU | 2(3) | 2880 |
| SRLI-ADD | 2(5) | 2880 |
| SW-MOVI.H | 3(4) | 1920 |
| MOVI.L-SW | 3(3) | 1728 |
| SH-LBCB | 5(2) | 960 |
| LBCB-LHU | 3(3) | 768 |
| SEQ-B | 2(2) | 480 |
| B-MOVI.H | 1(3) | 479 |
| MOVI.L-LW | 2(2) | 384 |
| MOIV.L-ADD | 1(1) | 384 |
| LW-SEQ | 3(3) | 192 |
| ADD-SW | 3(5) | 192 |
| AND-SEQ | 3(3) | 192 |
| MOVI.L-LHU | 3(3) | 192 |
| LBCB-MOVI.H | 3(3) | 192 |
| LW-AND | 4(4) | 192 |
| ADD-ADDI | 3(5) | 96 |
| ADD-MOVI.H | 1(1) | 96 |
| ADDI-MOVI.H | 2(4) | 96 |
| MOVI.L-SEQ | 3(2) | 96 |

By step S220, encoding of the instruction pairs having higher utilization rates in the group of instruction pairs IP0 is performed to assign similar binary encoding to these instruction pairs to generate a first instruction encoding table IET0, as shown in Table-3. For example, the encoding is performed on, for Table-2, five or ten instruction pairs having higher utilization rates, or the instruction pairs having utilization rates exceeding a threshold (e.g., the instruction pairs appearing for more than 1000 times), or all of the instruction pairs. In an example, the instruction pair having the highest utilization in the group of instruction pairs IP0 is first encoded, following by encoding other instruction pairs according to the utilization rate from high to low. The encoding operation indicates redefining the operation codes of the two instructions of an instruction pair, e.g., redefining either or both of the type code or the function code of the operation codes in this example, such that the two instructions have similar binary encoding (i.e., have a smaller Hamming distance). For example, the type codes of the instructions MOVI.H, MOVI.L, ADD, SW and SH in Table-1 are changed to 0111, 0111, 0011, 0010 and 0010 respectively. Based on the type codes, function codes of the instructions can be configured so that two adjacent instructions have similar instruction codes. For example, referring to the column T in Table-2, after the encoding operation, the Hamming distance of the instruction pair ADD-SRLI, or toggle count, changes from an original value of 5 (the number in the parentheses) to a value of 2, and the Hamming distance of the instruction pair ADD-SLLI changes from an original value of 4 to a value of 3. Further, the first instruction encoding table in Table-3 and the original instruction encoding table OIT in Table 1 have the same number of instructions, and encoding of one or more instructions (e.g., MOVI.H, MOVI.L, ADD, SW and SH) in the first instruction encoding table is different from that of the one or more instructions in the original instruction encoding table.

TABLE 3

| Type | Instruction |
|---|---|
| 0000 | NOP, TRAP |
| 0001 | LW, LH, LHU, LB, LBU |
| 0011 | ADD, SUB, AND, OR, XOR, MIN, MINU, MAX, MAXU, SLL, |
| | SRL, SRA |
| 0010 | SW, SH, SB |
| 0100 | ABS, NEG, NOT, COPY |
| 0101 | ADDI, SLLI, SRLI, SRAI |
| 0111 | MOVI.H, MOVI.L |
| 1101 | BRR, LBCB |
| 1110 | BR |
| 1111 | B |
| 1000 | ANDP, ORP |
| 1001 | NOTP |
| 1010 | SLT, SEQ |

Further, according to Table-2, a total toggle count of the instruction pairs of the application, i.e., a sum of products of number of appearance by toggle count of all the instruction pairs, is reduced from an original value of 168968 to a value of 117420 after the encoding operation. That is, the total toggle count is reduced by 30.50%.

Next, by way of step S230, the Hamming distance (the toggle count of the encoded instruction pairs as shown in the column T in Table-2) of each of the instruction pairs in the group of instruction pairs is determined according to the first instruction encoding table, and multiple instructions (denoted by a set IP1) are selected from the group of instruction pairs IP0 according to the Hamming distance and the number of appearance (e.g., the product of the Hamming distance by the number of appearance). Referring to Table-4, the products are ordered according to the product of the Hamming distance by the number of appearance of the instruction pairs, from high to low, to select multiple instruction pairs (i.e., instruction pairs) having greater products. For example, first five or ten instruction pairs having greater products, or instruction pairs having products exceeding a threshold (e.g., 1000 or above 7000) are selected for a re-encoding process in the next step. For illustration purposes, in this example, first four pairs of instructions (marked with an asterisk (*)) having the greatest products are selected.

TABLE 4

| Instruction pair | T | P |
|---|---|---|
| *ADD-SLLI | 3(4) | 17280 |
| *SLLI-ADD | 3(4) | 17280 |
| *ADD-SRLI | 2(5) | 13440 |
| *SRLI-SH | 3(2) | 11520 |
| MOVI.H-MOVI.L | 1(1) | 8162 |
| LHU-ADD | 2(5) | 7680 |
| SH-LHU | 2(3) | 5760 |
| SRLI-ADD | 2(5) | 5760 |
| SW-MOVI.H | 3(4) | 5760 |
| MOVI.L-MOVI.H | 1(1) | 5378 |
| MOVI.L-SW | 3(3) | 5184 |
| SH-LBCB | 5(2) | 4800 |
| LBCB-LHU | 3(3) | 2304 |
| SEQ-B | 2(2) | 960 |
| MOVI.L-LW | 2(2) | 768 |
| LW-AND | 4(4) | 768 |
| LW-SEQ | 3(3) | 576 |
| ADD-SW | 3(5) | 576 |
| AND-SEQ | 3(3) | 576 |
| MOVI.L-LHU | 3(3) | 576 |
| LBCB-MOVI.H | 3(3) | 576 |
| B-MOVI.H | 1(3) | 479 |
| MOIV.L-ADD | 1(1) | 384 |
| ADD-ADDI | 3(5) | 288 |
| MOVI.L-SEQ | 3(2) | 288 |
| ADDI-MOVI.H | 2(4) | 192 |
| ADD-MOVI.H | 1(1) | 96 |

By way of step S240, the selected instructions IP1 are re-encoded to obtain a second instruction encoding table IET1. As shown in Table-5, the selected instructions IP1 (e.g., SLLI, ADD, SRLI and SH) are re-encoded to assign each of the selected instructions with at least an additional binary encoding. In the determination of how to assign the additional instruction code, a topological relationship among the instructions can be determined to render an instruction encoding having a Hamming distance of 1, for example, between the instruction pairs SLLI-ADD, ADD-SRLI and SRLI-SH. Further, the second instruction encoding table IET1 is extended from the first instruction encoding table IET0, as shown in Table-3, and includes the additional instruction codes, as shown in Table-5. As such, each of the re-encoded instructions in the second instruction encoding table IET1 has two different instruction codes, e.g., the addition operation ADD has two instruction codes—0011 000 and 0110 011.

TABLE 5

| Instruction | Type | Function |
|---|---|---|
| SLLI | 0110 | 010 |
| ADD | 0110 | 011 |
| SRLI | 0110 | 001 |
| SH | 0110 | 000 |

However, the method for assigning additional binary encoding in the re-encoding operation is not limited to the above approach. For example, a reserved section(s) or reserved bits (e.g., unused bits in a certain type) in the first instruction encoding table IET0, as shown in Table-3, may be employed for assigning the additional instruction codes. As an instance, at least one reserved section which the selected instructions IP1 are to be assigned to may also be determined according to a topological relationship, to generate corresponding reconfigured, encoded additional instruction codes. Further, the re-encoding operation may also utilize both the reserved section(s) and extended section(s) (e.g., the newly added type as shown in Table-5) to assign the additional instruction codes. Moreover, the re-encoding of the foregoing selected instructions may assign the same number or different numbers of additional instruction code(s) to each of the selected instructions. These additional instruction codes may have the same or different type codes, and the topological relationship for these instructions may also correspond to the same or different Hamming distances.

By way of step S250, an instruction mapping table is generated. The instruction mapping table includes a mapping relationship between the second instruction encoding table IET1 and the original instruction encoding table OIT (such as Table-1). As an example, as shown in Table-6, the instruction mapping table includes a mapping relationship between multiple instruction codes representing the same instruction and an original instruction code. For example, the addition operation instruction ADD has two different codes in the second instruction encoding table IET1. Further, as shown in Table-6, the instruction mapping table also includes a mapping relationship between a reconfigured, re-encoded instruction code and an original instruction code, e.g., instruction SW, which indicates that a 32-bit word is stored to a data memory.

TABLE 6

| Instruction | Instruction code | Original instruction code |
|---|---|---|
| ADD | 0110 011, 0011 000 | 1010 000 |
| SW | 0010 001 | 0101 010 |

According to the exemplary second instruction encoding table IET1 above, the total toggle count of the instruction pairs of the application, after the re-encoding process, is reduced from an original value of 168968 to a value of 73740, i.e., reduced by 56.36%.

Therefore, according to the instruction mapping table generated by the instruction mapping module 110 with the foregoing examples, the processing unit 10 implemented based on the instruction encoding table of a PAC-Lite processor is capable of executing the target code of the application generated by the second instruction encoding table IET1 of the example. Further, the Hamming distance between every two executable codes of the application is in overall smaller than the Hamming distance between every two executable codes converted according to the instruction mapping table by the instruction mapping module 110. Hence, as the executable codes being transmitted on the bus 30 produce a reduced amount of power in switching, power consumption required by the electronic apparatus with the processing unit 10 for executing the application can be reduced.

In addition to the above example of the instruction set for a PAC-Lite processor, the method according to the embodiments in FIGS. 5 and 6 can also be applied to other appropriate instruction set architectures, e.g., an instruction set having a fixed length of 32-bits for MIPS processors. For example, the format of the instruction is represented by: ooooooss sssttttt dddddaaa aaffffffff, where o's indicate the operation code (6 bits), and f's indicate the function code (6 bits). For another example, the method according to the embodiments in FIGS. 5 and 6 may also be applied to a 32-bit instruction architecture of an ARM processor, or other 32-bit or 64-bit instruction architectures. Based on the descriptions of the above embodiments, a person having an ordinary skill in the art may implement the method and the electronic apparatus according to the embodiments to instruction sets for other processors by making appropriate modifications to the embodiments.

In the profiling step S20 in the foregoing embodiment, the second instruction encoding table generated is taken for illustration, not limiting its implementation. In some embodiments, the profiling step S20 may be implemented based on steps S210 and S220 to generate the first instruction encoding table (IET0), and an instruction mapping table is generated based on the first instruction encoding table (IET0). The first instruction table (IET0) is for the use of the compiler to generate executable codes of the application, and the instruction mapping table includes a mapping relationship between the first instruction encoding table (IET0) and the original instruction encoding table (OIT). Further, in some embodiments, the profiling step S20 may be implemented in other approaches; for example, implemented based on steps S210, S230 to S250 and the original instruction encoding table may be served as the first instruction encoding table in step S230. In addition, the above embodiments which are different from that in FIG. 6 can include further optimization or other processes to generate a new instruction encoding table and thus to generate an instruction mapping table by way of step S250. Further, a computing device may perform the steps of any embodiment according to FIG. 5 or 6 in an order different from that disclosed above.

A computer or computing apparatus readable information storage medium according to one embodiment is further provided. The information storage medium stores program code or one or multiple program modules. The reconfigurable instruction encoding method in FIG. 5, for example, may be implemented by executing the program code. A profiling step of the program code may be implemented according to the embodiment in FIG. 6 or other embodiments. For example, the computing apparatus readable information storage medium according to one embodiment is an optical information storage medium, a magnetic information storage medium, or a memory such as a memory card, firmware, read-only memory (ROM), random access memory (RAM), or a built-in memory of a programmable microcontroller. Further, the above method may be implemented as a library of one or more application interfaces. According to the foregoing embodiments, the program code or program module(s) may be implemented as a compiler or as program module(s) utilized by a compiler.

It will be apparent to those skilled in the art that various modifications and variations can be made to the disclosed embodiments. It is intended that the specification and examples be considered as exemplary only, with a true scope of the disclosure being indicated by the following claims and their equivalents.

What is claimed is:

1. A reconfigurable instruction execution method for an electronic apparatus, the method comprising:
loading an instruction mapping table to an processing unit of the electronic apparatus, wherein the processing unit comprising an instruction mapping module, an instruction decoding module, and an execution module;
fetching a first instruction of an application by the processing unit;
converting the first instruction to a target instruction by the instruction mapping module according to the instruction mapping table; and
decoding the target instruction by the instruction decoding module, and executing the decoded target instruction by the execution module.

2. The reconfigurable instruction execution method according to claim 1, wherein the processing unit obtains the instruction mapping table and fetches the first instruction from a memory unit of the electronic apparatus, and the first instruction represents at least one of a plurality of executable codes of the application.

3. The reconfigurable instruction execution method according to claim 1, wherein in the converting step, the first instruction comprises an encoded instruction code, the target instruction comprises an original instruction code, and the instruction mapping table includes a one-to-one mapping relationship between the encoded instruction code and the original instruction code; and the first instruction is converted to the target instruction according to the mapping relationship of the instruction mapping table by the instruction mapping module.

4. The reconfigurable instruction execution method according to claim 1, wherein in the converting step, the first instruction comprises an encoded instruction code, the target instruction comprises an original instruction code, and the instruction mapping table includes a many-to-one mapping relationship between the encoded instruction code and the original instruction code; and the first instruction is converted to the target instruction according to the mapping relationship of the instruction mapping table by the instruction mapping module.

5. The reconfigurable instruction execution method according to claim 2, wherein the instruction mapping table includes a function relationship between a plurality of encoded instruction codes and a plurality of original instruction codes, the executable codes of the application are based on the encoded instruction codes, and instructions of the original instruction codes are included in an instruction set for the processing unit.

6. The reconfigurable instruction execution method according to claim 5, wherein a first plurality of encoded instruction codes among the encoded instruction codes have a many-to-one mapping relationship with the original instruction codes.

7. The reconfigurable instruction execution method according to claim 6, wherein a Hamming distance between two adjacent executable codes among the executable codes of the application retrieved by the processing unit is substantially smaller than the Hamming distance between two adjacent executable codes converted by the instruction mapping module according to the instruction mapping table.

8. An electronic apparatus, comprising:
a processing unit, for executing an instruction according to an instruction mapping table, comprising:
an instruction mapping module, for converting a first instruction fetched by the processing unit to a target instruction according to the instruction mapping table;
an instruction decoding module, for decoding the target instruction; and
an execution module, for executing the decoded target instruction.

9. The electronic apparatus according to claim 8, further comprising:
a memory unit, for storing the instruction mapping table and a plurality of executable codes of an application;
wherein the first instruction represents at least one of the executable codes.

10. The electronic apparatus according to claim 9, wherein the processing unit enables the instruction mapping module to load the instruction mapping table before the processing unit executes the application according to the instruction mapping table.

11. The electronic apparatus according to claim 8, wherein the instruction mapping module comprises:
a memory; and
a control circuit, for loading the instruction mapping table into the memory, and converting the first instruction to the target instruction according to the instruction mapping table.

12. The electronic apparatus according to claim 8, further comprising:
an instruction fetching module, for fetching the first instruction; and
a multiplexer, having a plurality of input ends coupled to the instruction mapping module and the instruction fetching module, and a plurality of output ends coupled to the instruction decoding module;
wherein the processing unit, according to an indication signal, controls the multiplexer to select an output of either the instruction mapping module or the instruction fetching module to serve as an output of the multiplexer.

13. The electronic apparatus according to claim 9, wherein the instruction mapping table includes a function relationship between a plurality of encoded instruction codes and a plurality of original instruction codes, the executable codes of the application are based on the encoded instruction codes, and instructions of the original instruction codes are included in an instruction set for the processing unit.

14. The electronic apparatus according to claim 13, wherein a Hamming distance between two adjacent executable codes among the executable codes of the application retrieved by the processing unit is on the whole smaller than the Hamming distance between two adjacent executable codes converted by the instruction mapping module according to the instruction mapping table.

15. A reconfigurable instruction encoding method to be executed in a computing device, comprising:
(a) counting distribution of adjacent instruction pairs within an application, and accordingly determining a group of instruction pairs, wherein the group of instruction pairs includes a plurality of instruction pairs having higher utilization rates in the application;
(b) encoding each pair of the instruction pairs having the higher utilization rates to similar binary encodings and accordingly generating an instruction encoding table, wherein the generated instruction encoding table has a same number of instructions as that of an original instruction encoding table, and an encoding of at least one instruction in the generated instruction encoding table is different from that of the at least one instruction in the original instruction encoding table; and
(c) generating an instruction mapping table, wherein the instruction mapping table includes a mapping relationship between the generated instruction encoding table and the original instruction encoding table.

16. The reconfigurable instruction encoding method according to claim 15, wherein the step (b) comprises:
encoding each pair of the instruction pairs of the group of instruction pairs to similar binary encodings, from an instruction pair having a highest utilization rate among the instruction pairs in the group of instruction pairs according to utilization rates from high to low; and
generating the instruction encoding table, based on a plurality of instruction codes from the encoding of the instruction pairs.

17. The reconfigurable instruction encoding method according to claim 15, further comprising:
(d) generating executable codes of the application by compiling the instructions within the application according to the generated instruction encoding table.

18. The reconfigurable instruction encoding method according to claim 17, wherein in the step (b) the generated instruction encoding table serves as a first instruction encoding table, the method further comprises:
b1) determining a Hamming distance of each of the instruction pairs of the group of instruction pairs according to the first instruction encoding table, and selecting a plurality of instructions from the group of instruction pairs according to the Hamming distances and numbers of appearance of the instruction pairs of the group of instruction pairs; and
b2) re-encoding the selected instructions to obtain a second instruction encoding table, wherein the re-encoding assigns at least one additional instruction code to each one of the selected instructions correspondingly, the second instruction encoding table being extended based on the first instruction encoding table and including the additional instruction codes of the selected instructions;
wherein the steps (b) and (d) are executed with the generated instruction encoding table replaced by the second instruction encoding table.

19. The reconfigurable instruction encoding method according to claim 18, wherein in the step (b1), the selected instructions are instruction pairs having greater products of the Hamming distance and the number of appearance, in the group of instruction pairs.

20. The reconfigurable instruction encoding method according to claim 18, wherein in the step (d), executable codes having smaller Hamming distances are generated for two adjacent instructions within the application according to the second instruction encoding table.

21. The reconfigurable instruction encoding method according to claim 17, wherein when the executable codes are executed in an electronic apparatus based on the original instruction encoding table, the electronic apparatus converts the executable codes of the application and executes the converted executable codes.

22. A non-transitory computing apparatus readable information storage medium, storing a program code, the program code being capable of executing the steps of the reconfigurable instruction encoding method of claim 15.
